(19) United States
(12) Patent Application Publication
(10) Pub. No.: US 2024/0379979 A1
(43) Pub. Date: Nov. 14, 2024

(54) FUEL CELL SYSTEM

(71) Applicant: HONDA MOTOR CO., LTD., TOKYO (JP)

(72) Inventor: Takuya TAMURA, WAKO-SHI (JP)

(21) Appl. No.: 18/654,596

(22) Filed: May 3, 2024

(30) Foreign Application Priority Data
May 12, 2023 (CN) 202310539898.9

(51) Int. Cl. H01M 8/04746; B60L 1/00; B60L 7/10; B60L 50/75; B60L 58/34; H01M 8/04007; H01M 8/04089; H01M 8/0432; H01M 8/04858; H01M 16/00

(52) U.S. Cl. CPC H01M 8/04768; B60L 1/003; B60L 50/75; B60L 58/34; H01M 8/04007; H01M 8/04089; H01M 8/04358; H01M 8/04753; H01M 8/04947; H01M 16/006; B60L 7/10; H01M 2220/20; H01M 2250/20

(57) ABSTRACT

A fuel cell system that supplies, from a fuel cell or a power storage device, electric power for causing a motor to generate a driving force is configured such that, in a case where the power storage device cannot be charged with regenerative power generated by the motor, the regenerative power is first consumed by a heater alone. Then, while the regenerative power is consumed by the heater, the waste heat of the heater is recovered by a fuel cell stack to warm the fuel cell stack. When the temperature of the fuel cell stack rises to a first threshold temperature, the regenerative power is consumed by an air pump alone.

### CROSS-REFERENCE TO RELATED APPLICATIONS

This application is based upon and claims the benefit of priority from Chinese Patent Application No. 202310539898.9 filed on May 12, 2023, the contents of which are incorporated herein by reference.

### BACKGROUND OF THE INVENTION

### Field of the Invention

The present invention relates to a fuel cell system for driving a motor using electric power of a fuel cell which generates electric power by an electrochemical reaction between a fuel gas and an oxygen-containing gas.

### Description of the Related Art

In recent years, research and development have been conducted on fuel cells (FCs) that contribute to energy efficiency, in order to ensure that more people have access to affordable, reliable, sustainable and modern energy.

For example, JP 2019-140854 A (paragraph [0024]) discloses a technique (referred to as a first technique) in which, when regenerative power of a motor of a fuel cell vehicle becomes surplus, the surplus regenerative power is consumed by a heating unit (heater) of an air conditioning circuit.

Further, in the fuel cell vehicle of JP 2019-140854 A, there is disclosed a technique (referred to as a second technique) in which, when the temperature of the heat medium flowing through the heating unit reaches an upper limit temperature during consumption of the regenerative power, the heat medium is circulated between the air conditioning circuit and the fuel cell (paragraph [0025]).

Furthermore, in the fuel cell vehicle of JP 2019-140854 A, there is disclosed, as another embodiment, a technique (referred to as a third technique) in which, even when the temperature of the heat medium flowing through the heating unit reaches the upper limit temperature during consumption of the regenerative power, the heat medium is circulated between the air conditioning circuit and the fuel cell if the temperature of the fuel cell does not reach an upper limit temperature (paragraph [0029]).

### SUMMARY OF THE INVENTION

However, in the fuel cell vehicle disclosed in JP 2019-140854 A, the temperature of the fuel cell is not taken into consideration during the control in the first technique and the second technique, and therefore, there is a problem that the temperature of the fuel cell cannot be accurately controlled.

Therefore, there is a problem that, when the fuel cell vehicle is generating regenerative power while descending a long downhill, the fuel cell system may freeze.

Further in the fuel cell system disclosed in JP 2019-140854 A, the process is terminated when the third technique cannot be applied, and therefore, there is a problem that the regenerative power cannot be consumed.

An object of the present invention is to solve the above-described problem.

According to one aspect of the present invention, there is provided a fuel cell system comprising: a fuel cell configured to generate electric power by an electrochemical reaction between a fuel gas and an oxygen-containing gas that is supplied from an air pump; a fuel cell heat medium supply device configured to supply, to the fuel cell, a heat medium for controlling a temperature of the fuel cell; a fuel cell heat medium temperature sensor configured to detect a temperature of the heat medium for controlling the temperature of the fuel cell; a heater heat medium supply device configured to branch the heat medium flowing from the fuel cell heat medium supply device and supply, to a heater, the heat medium that has been branched; a heater heat medium temperature sensor configured to detect a temperature of the heat medium flowing through the heater heat medium supply device and controlling a temperature of the heater; and a switching valve configured to allow or block communication between the heat medium flowing through the fuel cell heat medium supply device and the heat medium flowing through the heater heat medium supply device, the fuel cell system being configured to supply auxiliary device electric power to the air pump, the fuel cell heat medium supply device, and the heater heat medium supply device, and to supply, to a motor, driving electric power for causing the motor to generate a driving force, the auxiliary device electric power and the driving electric power being supplied from at least one of a power storage device or the fuel cell, wherein in a case where the power storage device is not chargeable with regenerative power generated by the motor, the switching valve is switched to a communication state to increase a fuel cell heat medium temperature, when a temperature difference obtained by subtracting the fuel cell heat medium temperature from a heater heat medium temperature becomes equal to or greater than a threshold temperature difference while the fuel cell heat medium temperature is lower than a first threshold temperature, and the switching valve is switched to a shut-off state to perform power consumption control in which a rotational speed of the air pump is increased to cause the regenerative power to be consumed by the air pump, when the fuel cell heat medium temperature becomes equal to or higher than the first threshold temperature.

According to the present invention, in a case where regenerative power is generated by the motor and the power storage device cannot be charged with the regenerative power, the regenerative power is consumed by the heater alone, both the heater and the fuel cell, and the air pump alone in this order, and therefore, the regenerative power can be consumed accurately without freezing the fuel cell system.

When the regenerative power is generated, the power generation by the fuel cell is in an idle state, and the stack temperature is low. When the stack temperature is low, if the air pump is rotated at a high speed (normally rotated) by the regenerative power, the fuel cell system may freeze. In contrast, in the present invention, by providing a period in which the regenerative power is consumed by the heater alone and a period in which the regenerative power is consumed by both the heater and the fuel cell before the regenerative power is consumed by the air pump alone, the temperature of the fuel cell can be controlled accurately and the regenerative power can be consumed reliably. This in turn contributes to energy efficiency.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of a fuel cell vehicle in which a fuel cell system according to an embodiment of the present invention is incorporated;

FIG. 2 is a block diagram of a regenerative power consumption system including a detailed configuration of a regenerative power consumption control unit in a control device shown in FIG. 1;

FIG. 3 is a flowchart for explaining the operation of the fuel cell system;

FIG. 4 is an explanatory diagram of current-voltage characteristics of a fuel cell stack;

FIG. 5A is an explanatory diagram showing the flow of a heat medium in a case where a switching valve is in a shut-off state;

FIG. 5B is an explanatory diagram showing the flow of the heat medium in a case where the switching valve is in a communication state;

FIG. 6 is an explanatory table of power consumption control of regenerative power; and

FIG. 7 is a timing chart of an example used for explaining the consumption of the regenerative power.

### DETAILED DESCRIPTION OF THE INVENTION

### Embodiment

### [Configuration]

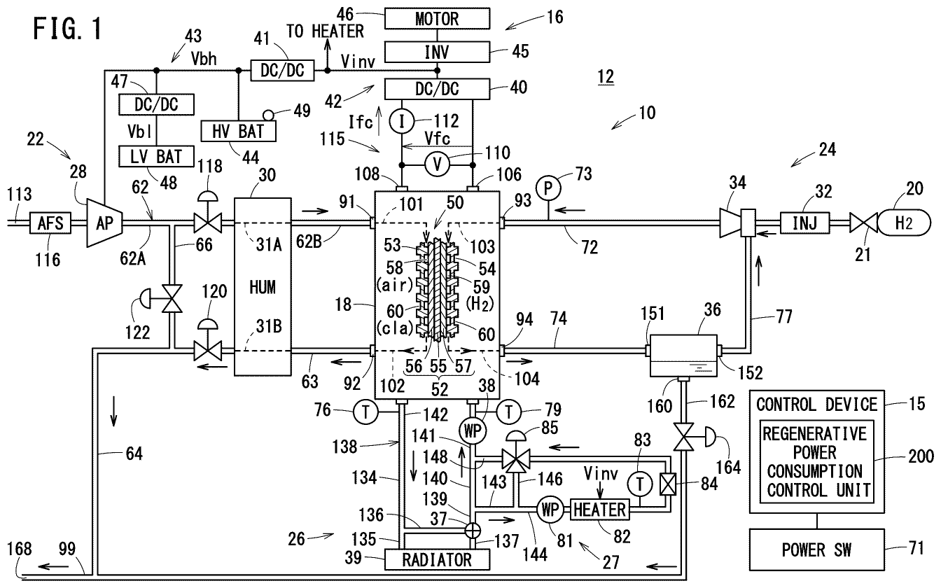

FIG. 1 is a schematic configuration diagram of a fuel cell vehicle 12 in which a fuel cell system 10 according to an embodiment of the present invention is incorporated.

The fuel cell system 10 can be incorporated in moving objects other than the fuel cell vehicle 12 such as a vessel, a flying object such as an aircraft, and a robot.

The fuel cell vehicle 12 includes the fuel cell system 10, an output unit 16 electrically connected to the fuel cell system 10, and a control device 15 that controls the entire fuel cell vehicle 12 (including the fuel cell system 10 and the output unit 16).

The number of the control devices 15 may not be one, and two or more control devices 15 may be provided, such as a control device for the fuel cell system 10 and a control device for the output unit 16, for example.

The fuel cell system 10 includes: a fuel cell stack (FC stack, also simply referred to as a fuel cell (FC)) 18, a fuel tank (hydrogen tank, fuel gas tank) 20, an oxygen-containing gas supply device 22, a fuel gas supply device 24, a fuel cell heat medium supply device 26, and a heater heat medium supply device 27. The oxygen-containing gas supply device 22 includes an air pump (AP) 28 and a humidifier (HUM) 30.

The fuel gas supply device 24 includes an injector (INJ) 32, an ejector 34, and a gas-liquid separator 36. The injector 32 may be replaced with a pressure reducing valve.

The fuel cell heat medium supply device 26 includes a heat medium pump (WP) 38, a thermo valve 37, and a radiator 39.

The heater heat medium supply device 27 includes a heat medium pump 81, a heater 82, a heater core 84, a switching valve 85 which is a three-way valve, heat medium flow paths 143, 144, 146, and 148 which connect these components, and a temperature sensor 83. The heater heat medium supply device 27 is configured as a part of an air conditioner. The output unit 16 includes a voltage conversion unit 42, a power storage unit 43, and a motor (electric motor) 46.

The voltage conversion unit 42 includes an inverter 45, a DC/DC converter 40 which is a step-up converter (SUC), and a DC/DC converter 41 which is a step-up/down converter (SUDC).

The power storage unit 43 includes a power storage device of a high voltage Vbh [V] (high-voltage battery, HV BAT) 44, a DC/DC converter 47 which is a step-down converter (SDC), and a power storage device of a low voltage Vbl [V] (low-voltage battery, LV BAT) 48.

The loads of the voltage conversion unit 42 connected to the fuel cell stack 18, and of the power storage unit 43 including the power storage device 44 of the high voltage Vbh include the motor 46 as a main device, the air pump 28 as a high-voltage auxiliary device to which electric power is supplied from the power storage device 44 of the high voltage Vbh, and low-voltage auxiliary devices (for example, the air conditioner, and various sensors, various electromagnetic valves, the injector 32, and the heat medium pump 38, which will be described later). The low-voltage auxiliary devices are supplied with electric power from the power storage device 48 that generates the low voltage Vbl.

The heater 82 is configured such that a high voltage Vinv related to regenerative power can be applied thereto from the voltage conversion unit 42. Further, although not illustrated, the heater 82 is configured to be applied with the high voltage Vbh so as to be able to consume electric power (generate heat) during heating. Instead of the high voltage Vinv, the high voltage Vbh obtained by stepping down the regenerative power by the DC/DC converter 41 may be applied to the heater 82.

The DC/DC converter 40 performs step-up conversion of an output voltage Vfc, which is a generated voltage (DC voltage) from the fuel cell stack 18, and applies the stepped up output voltage Vfc to the DC end of the inverter 45 and the DC/DC converter 41 as a driving high voltage.

The DC/DC converter 41 steps down the driving high voltage to the high voltage Vbh which is a battery voltage of the power storage device 44, and charges the power storage device 44 of the high voltage Vbh.

The DC/DC converter 47 steps down the high voltage Vbh to the low voltage Vbl, and charges the power storage device 48 of the low voltage Vbl.

The high voltage Vinv obtained by step-up conversion of the high voltage Vbh by the DC/DC converter 41 and/or the high voltage Vinv obtained by step-up conversion of the output voltage Vfc by the DC/DC converter 40 is applied to the DC end of the inverter 45 as a driving voltage. The inverter 45 converts the high voltage Vinv of direct current into three-phase alternating current to drive the motor 46. The fuel cell vehicle 12 travels by the driving force generated by the motor 46.

The inverter 45 converts the regenerative voltage of the motor 46 into the high voltage Vinv of direct current. The high voltage Vinv of direct current is stepped down to the high voltage Vbh by the DC/DC converter 41. The high voltage Vbh is applied to the power storage device 44 to charge the power storage device 44.

When the state of charge (SOC) of the power storage device 44 exceeds a full charge threshold SOCth of a fully charged state, the regenerative voltage (regenerative power) of the high voltage Vinv is consumed (so-called power waste is performed) by the heater 82 or the air pump 28. The SOC of the power storage device 44 is detected by an SOC sensor 49 and acquired by the control device 15.

In the fuel cell stack 18, a plurality of power generation cells 50 are stacked. The power generation cells 50 each include a membrane electrode assembly 52, and separators 53 and 54 that sandwich the membrane electrode assembly 52.

The membrane electrode assembly 52 includes, for example, a solid polymer electrolyte membrane 55 which is a perfluorosulfonic acid thin film containing water, and a cathode 56 and an anode 57 that sandwich the solid polymer electrolyte membrane 55.

The cathode 56 and the anode 57 each include a gas diffusion layer (not illustrated) made of carbon paper or the like. The porous carbon particles having a platinum alloy supported on the surface thereof are uniformly applied to the surface of the gas diffusion layer to form an electrode catalyst layer (not illustrated). The electrode catalyst layers are formed on both surfaces of the solid polymer electrolyte membrane 55.

A cathode flow field (oxygen-containing gas flow field) 58 that connects an oxygen-containing gas inlet connection port 101 and an oxygen-containing gas outlet connection port 102 and that lies along the cathode 56 is formed on the surface of the separator 53 that faces the membrane electrode assembly 52.

An anode flow field (fuel gas flow field) 59 that connects a fuel gas inlet connection port 103 and a fuel gas outlet connection port 104 and that lies along the anode 57 is formed on the surface of the separator 54 that faces the membrane electrode assembly 52.

A voltage sensor 110 for detecting the output voltage Vfc of the fuel cell stack 18 is provided between wires that respectively connect a positive electrode terminal 108 and a negative electrode terminal 106 to the DC/DC converter 40. Further, a current sensor 112 for detecting a generated current Ifc is provided on the wire connecting the positive electrode terminal 108 to the DC/DC converter 40.

The voltage sensor 110 and the current sensor 112 constitute a power generation state acquisition unit 115 that detects generated electric power as the power generation state. The voltage sensor 110 may be provided for each power generation cell 50 or for the plurality of power generation cells 50.

The air pump 28 includes an air pump inverter (not illustrated) to which the high voltage Vbh of the high-voltage power storage device 44 is applied, a mechanical supercharger driven by an air pump motor (not illustrated) controlled by a three-phase AC output of the air pump inverter, and the like.

The air pump 28 has a function of, for example, sucking and pressurizing outside air (atmosphere, air) from an outside air intake port 113 and supplying the pressurized outside air to the fuel cell stack 18 through the humidifier 30.

The humidifier 30 includes a flow path 31A and a flow path 31B. The air (oxygen-containing gas), which has been compressed, heated to a high temperature, and dried by the air pump 28, flows through the flow path 31A. An oxygen-containing off-gas, which is an exhaust gas discharged from the oxygen-containing gas outlet connection port 102 of the fuel cell stack 18 through an oxygen-containing off-gas outlet 92, flows through the flow path 31B.

The humidifier 30 has a function of humidifying the oxygen-containing gas supplied from the air pump 28. That is, the humidifier 30 transfers the water contained in the oxygen-containing off-gas from the flow path 31B to the supplied gas (oxygen-containing gas) flowing through the flow path 31A through the porous membranes in the humidifier 30 to humidify the oxygen-containing gas, and supplies the humidified oxygen-containing gas to the fuel cell stack 18 through an oxygen-containing gas inlet 91.

In an oxygen-containing gas supply flow path 62 (including oxygen-containing gas supply flow paths 62A and 62B) from the outside air intake port 113 to the oxygen-containing gas inlet 91, there are provided an air flow sensor (AFS: flow rate sensor) 116, the air pump 28, an inlet-side stop valve 118, and the humidifier 30, in this order from the outside air intake port 113. It should be noted that the flow paths such as the oxygen-containing gas supply flow path 62 shown by double lines are formed of pipes (the same applies hereinafter). The opening degree of the inlet-side stop valve 118 can be variably controlled by the control device 15, and the inlet-side stop valve 118 opens and closes the oxygen-containing gas supply flow path 62.

An oxygen-containing off-gas discharge flow path 63 communicating with the oxygen-containing off-gas outlet 92 is provided with the humidifier 30 and an outlet-side stop valve 120 that also functions as a back pressure valve, in this order from the oxygen-containing off-gas outlet 92. The opening degree of the outlet-side stop valve 120 can be variably controlled by the control device 15, and the outlet-side stop valve 120 opens and closes the oxygen-containing off-gas discharge flow path 63.

A bypass flow path 66 that connects the oxygen-containing gas supply flow path 62 and the oxygen-containing off-gas discharge flow path 63 is provided between the inlet of the inlet-side stop valve 118 and the outlet of the outlet-side stop valve 120. The bypass flow path 66 is provided with a bypass valve 122 that opens and closes the bypass flow path 66.

The opening degree of the bypass valve 122 can be variably controlled by the control device 15. The bypass valve 122 adjusts the flow rate of the oxygen-containing gas bypassing the fuel cell stack 18. The merged path of the bypass flow path 66 and the oxygen-containing off-gas discharge flow path 63 communicates with a discharge flow path 64.

The fuel tank 20 includes an electromagnetically operated hydrogen shut-off valve 21, the fuel tank 20 being a container that stores high-purity hydrogen compressed at a high pressure.

A fuel gas (hydrogen) discharged from the fuel tank 20 flows through the injector 32 and the ejector 34 provided in a fuel gas supply flow path 72, and is supplied to the inlet of the anode flow field 59 through a fuel gas inlet 93 and the fuel gas inlet connection port 103 of the fuel cell stack 18.

In this case, the fuel gas supply flow path 72 is provided with a pressure sensor 73 for detecting (measuring) a gas pressure (anode pressure) Pa of the fuel gas in the fuel gas supply flow path 72.

The outlet of the anode flow field 59 is connected to an inlet 151 of the gas-liquid separator 36 through the fuel gas outlet connection port 104, a fuel off-gas outlet 94, and a fuel off-gas discharge flow path 74 for the fuel off-gas, and the fuel off-gas, which is a hydrogen-containing gas, is supplied from the anode flow field 59 to the gas-liquid separator 36.

In practice, a part of water generated by power generation of the fuel cell stack 18 is diffused backward through (permeates) the membrane electrode assembly 52 from the cathode flow field 58, and moves to the anode flow field 59.

In a case where the back-diffused water cannot be appropriately discharged from the fuel off-gas discharge flow path 74 or a circulation flow path 77, the water enters the anode 57 of the fuel cell stack 18 and blocks the anode flow field (fuel gas flow field) 59, which causes deterioration in power generation stability of the fuel cell stack 18.

In order to prevent this disadvantage, the gas-liquid separator 36 for temporarily storing water separates the fuel off-gas into a gas component and a liquid component (liquid water).

The gas component (fuel off-gas) of the fuel off-gas is discharged from a gas discharge outlet 152 of the gas-liquid separator 36 and is supplied to the suction port of the ejector 34 through the circulation flow path 77.

The liquid component (liquid water) of the fuel off-gas, which is the back-diffused water, flows from a liquid discharge outlet 160 of the gas-liquid separator 36 through a drain flow path 162 provided with a drain valve 164, is mixed with the exhaust gas discharged from the discharge flow path 64, and is discharged to the outside air through a discharge flow path 99 and an exhaust gas discharge port 168.

A part of the fuel off-gas (hydrogen-containing gas) is discharged to the drain flow path 162 together with the liquid water. Further, after the discharge of the liquid water is completed, only the fuel off-gas (hydrogen-containing gas) is discharged to the drain flow path 162.

In order to dilute the hydrogen gas in the fuel off-gas and discharge the diluted hydrogen gas to the outside, a part of the oxygen-containing gas discharged from the air pump 28 is supplied to the discharge flow path 64 through the bypass flow path 66.

If the drain valve 164 is kept open even after the water is drained from the drain flow path 162, hydrogen is wasted. In order to avoid wasting hydrogen, the drain valve 164 needs to be appropriately closed after water is discharged from the gas-liquid separator 36.

The oxygen-containing gas supplied through the bypass flow path 66 for the oxygen-containing gas is mixed with the oxygen-containing off-gas (including the remaining fuel off-gas which has not been consumed in the reaction) flowing through the oxygen-containing off-gas discharge flow path 63, and the mixture flows through the discharge flow path 64. The discharge flow path 64 communicates with the drain flow path 162, and merges with the drain flow path 162 to communicate with the discharge flow path 99.

In the discharge flow path 99, the fuel gas in the mixed fluid of the liquid water and the fuel off-gas discharged from the drain flow path 162 is diluted by the oxygen-containing off-gas supplied from the discharge flow path 64, and the diluted fuel gas is discharged to the outside (atmosphere) of the fuel cell vehicle 12 through the exhaust gas discharge port 168.

The fuel cell heat medium supply device 26 of the fuel cell system 10 includes a fuel cell heat medium flow path 138 for causing a heat medium (coolant) to flow through a heat medium flow field 60 provided in the fuel cell stack 18. The fuel cell heat medium flow path 138 includes, in addition to the heat medium flow field 60, a heat medium discharge flow path 134, a heat medium supply flow path 135, a heat medium bypass flow path 136, a heat medium discharge flow path 137, the thermo valve 37, heat medium supply flow paths 139, 140, and 141, and the heat medium pump 38.

The radiator 39 for cooling the heat medium is connected between the outlet side of the heat medium supply flow path 135 and the inlet side of the heat medium discharge flow path 137.

The radiator 39 cools the heat medium. The heat medium pump 38 circulates the heat medium in the fuel cell heat medium flow path 138.

A temperature sensor 76 is provided in the heat medium discharge flow path 134. A temperature sensor 79 is provided in the heat medium supply flow path 141. In this embodiment, the temperature sensor 79 is referred to as a fuel cell heat medium temperature sensor 79.

When the temperature of the heat medium flowing through the heat medium bypass flow path 136 becomes equal to or higher than a predetermined temperature, the thermo valve 37 is switched to bring the heat medium bypass flow path 136 into the shut-off state, and the heat of the heat medium is removed by the radiator 39. In addition, when the temperature of the heat medium in the heat medium bypass flow path 136 is lower than the predetermined temperature, the thermo valve 37 is switched to bring the heat medium bypass flow path 136 into the communication state, and the heat medium flowing to the heat medium discharge flow path 134 is not cooled by the radiator 39. The above-described components of the fuel cell system 10 are controlled in an integrated manner by the control device 15.

It should be noted that the inlet-side stop valve 118, the outlet-side stop valve 120, the drain valve 164, and the switching valve 85 are flow rate adjusting valves whose opening degrees are controlled by the control device 15, but may be electromagnetically controlled on-off valves that are duty-controlled.

The control device 15 is constituted by an electronic control unit (ECU). The ECU is constituted by a computer including one or more processors (CPUs), a memory, an input/output interface, and an electronic circuit. The one or more processors (CPUs) execute non-illustrated programs (computer-executable instructions) stored in the memory.

The processors of the control device 15 execute calculation according to the programs to control the operation of the fuel cell vehicle 12 and the fuel cell system 10.

Further, the control device 15 also functions as a regenerative power consumption (power waste) control unit 200 by executing the program.

A power switch (power SW) 71 of the fuel cell vehicle 12 is connected to the control device 15. The power switch 71 is operated by a user, and the power generation operation of the fuel cell stack 18 of the fuel cell system 10 is started or continued when the power switch 71 is ON, or terminated when the power switch 71 is OFF. Further, an accelerator pedal sensor and a vehicle speed sensor (both not illustrated) are also connected to the control device 15. The power SW 71 can perform so-called RTC activation (automatic on/off) of the fuel cell system 10 by using a non-illustrated timer (time measuring instrument).

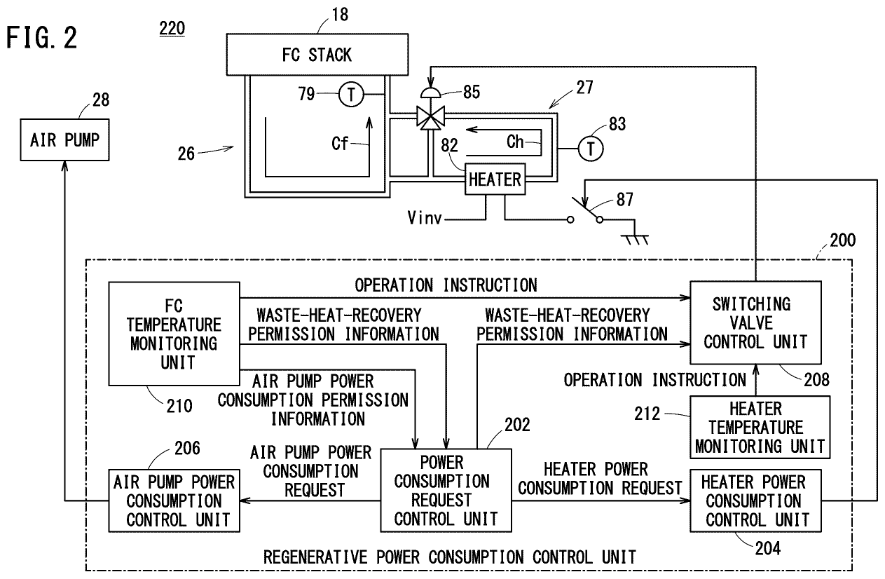

FIG. 2 shows a regenerative power consumption system 220 including a detailed configuration of the regenerative power consumption control unit 200. The regenerative power consumption control unit 200 controls the operations of the air pump 28, the heater 82, the fuel cell heat medium supply device 26, and the heater heat medium supply device 27 to efficiently consume the regenerative power.

The regenerative power consumption control unit 200 includes a power consumption request control unit 202, a heater power consumption control unit 204, an air pump power consumption control unit 206, a switching valve control unit 208, an FC temperature monitoring unit 210, and a heater temperature monitoring unit 212.

It should be noted that the power supply input terminal of the heater 82 is applied with the high voltage Vinv, and the ground terminal thereof is grounded via a switch 87. When the switch 87 is closed by the heater power consumption control unit 204, the heater 82 generates heat by the current supplied from the inverter 45 that converts the regenerative voltage into the high voltage Vinv. The heater 82 generates heat, whereby the regenerative power is consumed and the temperature of a heater heat medium Ch rises. It should be noted that, during heating, the heater 82 generates heat also by the current supplied from the power storage device 44 of the high voltage Vbh.

### [Operation]

### [Description Using Flowchart]

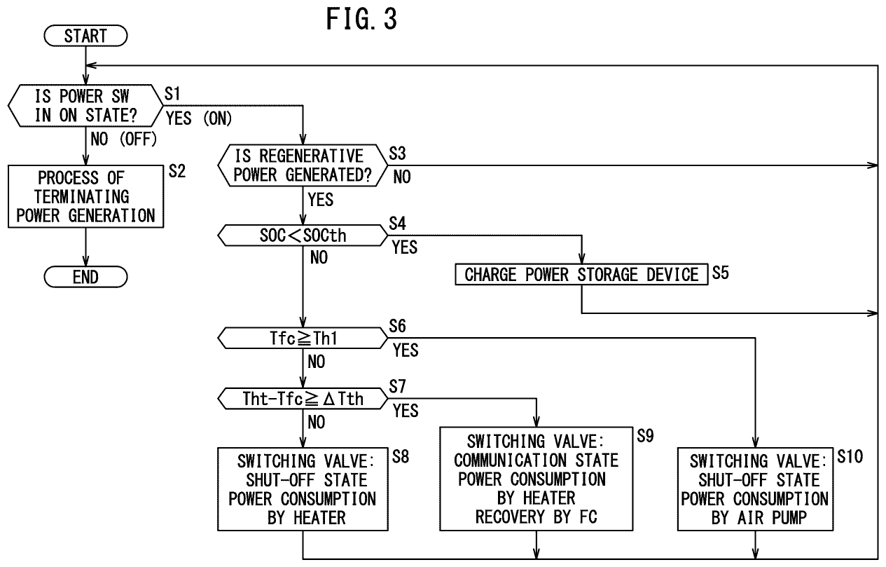

The fuel cell system 10 according to the present embodiment is basically configured as described above. Hereinafter, the operation of the fuel cell system 10 related to the power consumption control of the regenerative power of the motor 46 will be described with reference to the flowchart of FIG. 3.

In step S1, the control device 15 determines whether the power switch 71 is in an ON state or an OFF state, and in a case where the power switch 71 is continuously in the OFF state or is switched from the ON state to the OFF state (step S1: NO), the control device 15 advances the process to step S2. In step S2, the control device 15 performs a process of terminating the power generation.

On the other hand, in a case where the power switch 71 is continuously in the ON state or is switched from the OFF state to the ON state (step S1: YES), the control device 15 advances the process to step S3.

In the present embodiment, in step S1, the power switch 71 of the fuel cell vehicle 12 equipped with the fuel cell system 10 is turned on (step S1: YES) after being charged during parking at a cottage on a mountain top (in the highland). Thereafter, the fuel cell vehicle 12 is assumed to be in a downhill traveling state in which the fuel cell vehicle 12 is descending a downhill from the highland mainly in a so-called electric vehicle (EV) travel mode while applying regenerative braking without depressing the accelerator pedal. The EV travel mode refers to a traveling state in which the motor 46 is driven only with the electric power of the power storage device 44.

During the downhill traveling, the fuel cell system 10 is brought into a power generation stop state in which the fuel gas is shut off, or into an idle power generation state in which very low electric power is generated for avoiding deterioration at an open circuit voltage Vocv. In step S3, the control device 15 determines whether or not regenerative power is being generated by the motor 46.

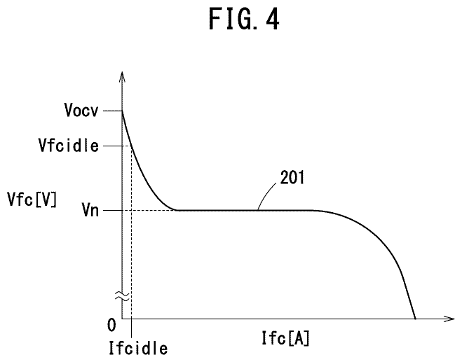

FIG. 4 shows current-voltage characteristics 201 of the fuel cell stack 18. The horizontal axis represents the generated current Ifc [A], and the vertical axis represents the generated voltage Vfc [V]. The fuel cell vehicle 12 performs normal traveling such as flat ground traveling at a normal generated voltage Vn [V] at which the generated voltage Vfc does not substantially change with respect to an increase or decrease in the generated current Ifc. During the downhill traveling, the fuel cell stack 18 is maintained in a slight power generation state at an idle current Ifcidle (idle voltage Vfcidle), that is, a so-called idle power generation state. While the idle power generation state is maintained, the temperature of the fuel cell stack 18 is detected. In the present embodiment, the temperature of the fuel cell stack 18 is detected by the fuel cell heat medium temperature sensor 79 provided at the heat medium supply port for the fuel cell stack 18, and is acquired as a fuel cell heat medium temperature Tfc by the FC temperature monitoring unit 210. In the idle power generation state, the fuel cell heat medium temperature Tfc gently rises, including the rise in the outside air temperature from the highland toward the lowland.

During the downhill traveling and when the accelerator pedal is not depressed, the motor 46 generates a braking force (regenerative braking force) and regenerative power, the determination by the control device 15 in step S3 is affirmative (step S3: YES), and the control device 15 advances the process to step S4.

In step S4, the control device 15 acquires the SOC of the power storage device 44 using the SOC sensor 49, and determines whether the acquired SOC is less than the full charge threshold SOCth.

In a case where the SOC is less than the full charge threshold SOCth (step S4: YES, SOC<SOCth), the control device 15 advances the process to step S5, and in a case where the SOC is equal to or greater than the full charge threshold SOCth (step S4: NO, SOC≥SOCth), the control device 15 advances the process to step S6.

In step S5, the control device 15 converts the regenerative power of the motor 46 into the regenerative power of the high voltage Vinv via the inverter 45 and the DC/DC converter 41. The control device 15 steps down the high voltage Vinv to the high voltage Vbh using the DC/DC converter 41, charges the power storage device 44 with the regenerative power of the high voltage Vbh, and advances the process to step S1.

If the power storage device 44 cannot be charged, then in step S6, the power consumption request control unit 202 of the control device 15 monitors whether the heat medium temperature (referred to as the fuel cell heat medium temperature Tfc) detected by the temperature sensor 79 and monitored by the FC temperature monitoring unit 210 is equal to or higher than a first threshold temperature Th1.

In the initial state of the downhill traveling from the highland, the fuel cell stack 18 is cold, and thus the determination in step S6 is negative (step S6: NO, the fuel cell heat medium temperature Tfc is lower than the first threshold temperature Th1), and the control device 15 advances the process to step S7.

In step S7, the power consumption request control unit 202 of the control device 15 determines whether or not a temperature difference (Tht−Tfc) obtained by subtracting the fuel cell heat medium temperature Tfc from a heat medium temperature (referred to as a heater heat medium temperature Tht) detected by the temperature sensor 83 and monitored by the heater temperature monitoring unit 212 is equal to or greater than a threshold temperature difference ΔTth.

In the initial state of the downhill traveling from the highland, the heater 82 is also cold, and thus the determination in step S7 is negative (step S7: NO, (Tht−Tfc)<ΔTth), and the control device 15 advances the process to step S8 (first power consumption control).

In step S8, the heater temperature monitoring unit 212 sends an operation instruction for the switching valve 85, to the switching valve control unit 208. Further, in step S8, the power consumption request control unit 202 may instruct the heater power consumption control unit 204 to request the heater power consumption. In response to the operation instruction, the switching valve control unit 208 switches the switching valve 85 to the shut-off state.

In response to the instruction of the heater power consumption request, the heater power consumption control unit 204 energizes the heater 82. In the energized state, the heater 82 generates heat with the regenerative power of the high voltage Vinv.

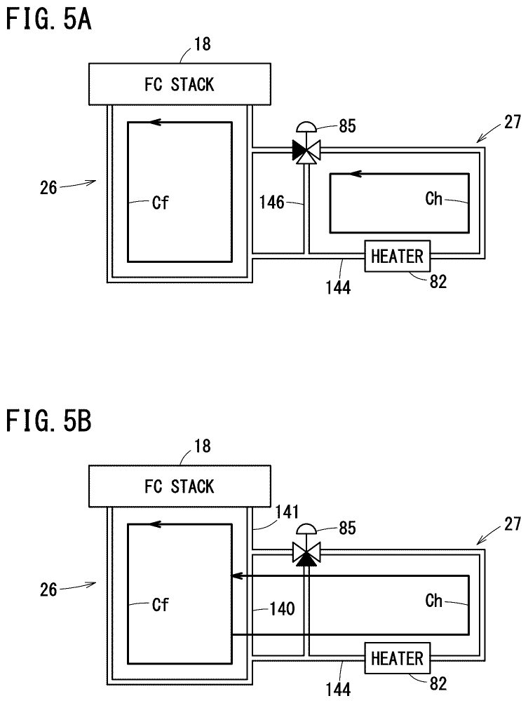

FIG. 5A shows circulation passages of the heat media Cf and Ch in a case where the switching valve 85 is switched to the shut-off state (the state in which the fuel cell heat medium Cf and the heater heat medium Ch are isolated from each other) (during the process of step S8).

Since the heater heat medium Ch is circulating in the heater heat medium supply device 27, the temperature Tht of the heater heat medium Ch gradually rises in accordance with the consumption of the regenerative power by the heater 82 that is based on the control of the heater power consumption control unit 204. The power consumption control of the regenerative power in step S8 is referred to as first power consumption control or heater alone-power consumption control.

After the process of step S8, the heater heat medium temperature Tht rises during the first power consumption control of step S8 after step S1: YES, step S3: YES, step S4: NO, step S6: NO, and step S7: NO. When the heater heat medium temperature Tht rises and the determination in step S7 becomes affirmative (step S7: YES, (Tht−Tfc)≥ΔTth), the control device 15 advances the process to step S9.

When the determination in step S7 becomes affirmative, the control device 15 may limit the consumption of the regenerative power by the heater 82 (the heater heat medium supply device 27) so that the heater heat medium temperature Tht does not rise any more.

In step S9, the heater temperature monitoring unit 212 of the regenerative power consumption control unit 200 sends, to the switching valve control unit 208, an operation instruction for bringing the switching valve 85 into the communication state.

Further, in step S9, upon receiving waste-heat-recovery permission information from the FC temperature monitoring unit 210 (step S7: YES), the power consumption request control unit 202 sends the waste-heat-recovery permission information to the switching valve control unit 208.

In response to the waste-heat-recovery permission information and the operation instruction, the switching valve control unit 208 switches the switching valve 85 from the shut-off state to the communication state (the state in which the fuel cell heat medium Cf and the heater heat medium Ch are in communication with each other). When the switching valve 85 is in the communication state, the opening degree of the switching valve 85 may be adjusted to an intermediate opening degree between the fully opened state and the closed state.

FIG. 5B shows circulation passages of the heat media Cf and Ch in a case where the switching valve 85 is switched to the communication state (during the process of step S9).

The heater heat medium Ch flowing through the flow path 144 of the heater heat medium supply device 27 passes through the switching valve 85, merges with the fuel cell heat medium Cf flowing through the flow path 140, and is introduced into the fuel cell stack 18 via the flow path 141.

In the process of step S9, the waste heat of the heater heat medium Ch whose temperature has been increased by the heater 82 is transferred to the fuel cell heat medium Cf, and the temperature of the fuel cell stack 18 is increased, whereby the fuel cell stack 18 is brought into the waste heat recovery state. The power consumption control of the regenerative power in step S9 is referred to as second power consumption control or heater-fuel cell combined power consumption control.

When the waste heat recovery state is entered by performing the process of step S9, the rate of increase in the temperature of the fuel cell stack 18, that is, the rate of increase in the fuel cell heat medium temperature Tfc increases. On the other hand, the heater heat medium temperature Tht gradually decreases.

Therefore, after the process of step S9, the processes of step S1: YES, step S3: YES, step S4: NO, step S6: NO, step S7: YES, and step S9 are repeated.

During the repetition of these processes, the switching valve control unit 208 may adjust the communication degree (opening degree) of the switching valve 85 based on the fuel cell heat medium temperature Tfc monitored by the FC temperature monitoring unit 210 and the heater heat medium temperature Tht monitored by the heater temperature monitoring unit 212 so as to satisfy the conditional expression (Tht−Tfc≥ΔTth) in step S7.

During the repetition of these processes, when the fuel cell heat medium temperature Tfc of the fuel cell stack 18 rises, and the determination in step S6 becomes affirmative (step S6: YES, Tfc≥Th1), the control device 15 (the power consumption request control unit 202 of the regenerative power consumption control unit 200) advances the process to step S10.

In step S10, the FC temperature monitoring unit 210 of the regenerative power consumption control unit 200 sends, to the switching valve control unit 208, an operation instruction for switching the switching valve 85 from the communication state to the shut-off state, and sends air pump power consumption permission information to the power consumption request control unit 202.

In step S10, the power consumption request control unit 202 withdraws the heater power consumption request issued to the heater power consumption control unit 204. Further, the power consumption request control unit 202 withdraws the waste-heat-recovery permission information sent to the switching valve control unit 208. Furthermore, the power consumption request control unit 202 sends an air pump power consumption request to the air pump power consumption control unit 206.

In step S10, the air pump power consumption control unit 206 increases the rotational speed of the air pump 28 to a predetermined rotational speed, and also opens the bypass valve 122 so that the oxygen-containing gas from the air pump 28 is not excessively supplied to the fuel cell stack 18. In step 510, the regenerative power of the motor 46 is consumed by the air pump 28. The power consumption control of the regenerative power in step S10 is referred to as third power consumption control or air pump-alone power consumption control.

After the process of step S10, the fuel cell vehicle 12 finishes the downhill traveling while the processes of step S1: YES, step S3: YES, step S4: NO, step S6: YES, and step S10 are repeated. When the downhill traveling is finished and switched to, for example, the flat ground traveling, the determination in step S3 becomes negative (step S3: NO), and the fuel cell system 10 of the fuel cell vehicle 12 terminates the power consumption control of the regenerative power.

During the consumption control of the regenerative power in step S10 (third power consumption control), cooling of the fuel cell heat medium Cf by the radiator 39 may also be performed by adjusting the opening degree of the thermo valve 37, in order to maintain the fuel cell heat medium temperature Tfc at the constant first threshold temperature Th1.

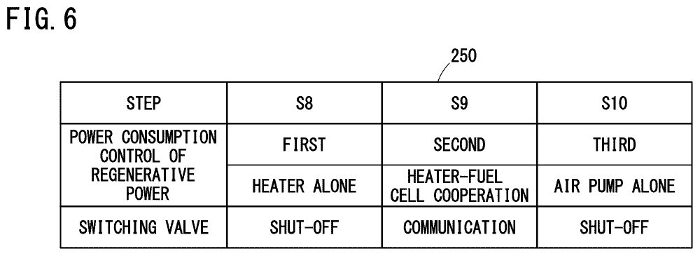

For ease of understanding, an explanatory table 250 in FIG. 6 collectively shows the power consumption control of the regenerative power (including the control of the switching valve 85) in steps S8 to S10 described with reference to the flowchart of FIG. 3.

### [Explanation Using Timing Chart]

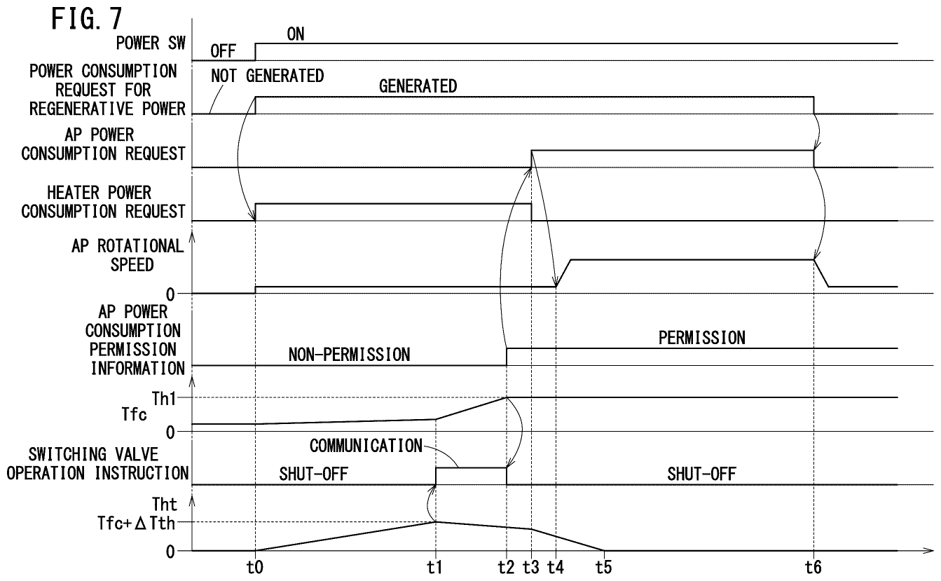

An example of the operation described using the flowchart of FIG. 3 will be described with reference to the timing chart of FIG. 7. In FIG. 7, an air pump power consumption request (shown in the third row from the top in FIG. 7) is a request for causing the regenerative power to be consumed by the air pump 28, and the heater power consumption request (shown in the fourth row from the top in FIG. 7) is a request for causing the regenerative power to be consumed by the heater 82. The regenerative power may be directly consumed by the auxiliary devices without passing through the power storage device 44. Alternatively, the regenerative power may be consumed by the power storage device 44 being repeatedly charged and discharged so as not to exceed the full charge threshold SOCth while electric power is supplied from the power storage device 44 to the auxiliary devices. In either case, it is determined that the regenerative power is consumed.

At time point t0, the power switch 71 (shown in the uppermost row in FIG. 7) transitions from the OFF state to the ON state (step S1: YES). At time point t0, the power consumption request (shown in the second row from the top in FIG. 7) for the regenerative power generated accompanying the downhill traveling of the fuel cell vehicle 12 (step S3: YES) is generated, and at the same time, the power consumption request control unit 202 issues the heater power consumption request to the heater power consumption control unit 204.

At time point t0, the heater 82 is energized while the switching valve 85 is in the shut-off state, and the consumption of the regenerative power is started (step S8, FIG. 5A, the first power consumption control).

At time point t0, the fuel cell system 10 waits in the power generation stop state, or starts power generation aiming at the idle power generation state. At time point t0, the fuel cell vehicle 12 equipped with the fuel cell system 10 starts descending a downhill in the EV travel mode using the motor 46.

The heater heat medium temperature Tht (shown in the lowermost row in FIG. 7) starts to rise from time point t0 due to the power consumption by the heater 82 of the regenerative power generated by the motor 46 during the downhill traveling (the first power consumption control by the heater alone).

At time point t1, when the temperature difference (Tht−Tfc) obtained by subtracting the fuel cell heat medium temperature Tfc (shown in the third row from the bottom in FIG. 7) from the heater heat medium temperature Tht becomes equal to or greater than the threshold temperature difference ΔTth {(Tht−Tfc)≥ΔTth}, the waste-heat-recovery permission information is sent from the power consumption request control unit 202 to the switching valve control unit 208. In a case where the inequality {(Tht−Tfc)≥ΔTth} is modified to an inequality {Tht≥(Tfc+ΔTth)}, when the heater heat medium temperature Tht becomes equal to or higher than a temperature obtained by adding the threshold temperature difference ΔTth to the fuel cell heat medium temperature Tfc, the waste-heat-recovery permission information is sent from the power consumption request control unit 202 to the switching valve control unit 208.

In response to a switching valve operation instruction (shown in the second row from the bottom in FIG. 7) that is based on the waste-heat-recovery permission information and issued by the switching valve control unit 208, the switching valve 85 is brought into the communication state (FIG. 5B) between time point t1 and time point t2, and the waste heat generated by the heater 82 is recovered by the fuel cell stack 18 (step S9, FIG. 5B, the second power consumption control by heater-fuel cell cooperation). Therefore, as shown in the third row from the bottom in FIG. 7, the rate of increase in the fuel cell heat medium temperature Tfc increases between time point t1 and time point t2. At time point t2, the fuel cell heat medium temperature Tfc reaches the first threshold temperature Th1 (step S6: YES).

At time point t2, the air pump power consumption permission information (shown in the fourth row from the bottom in FIG. 7) shifts from the “non-permission” state to the “permission” state. Further, after the time point t2, the fuel cell heat medium temperature Tfc is controlled to be the first threshold temperature Th1, which is a constant value.

As a result, at time point t3, the power consumption request control unit 202 issues the air pump power consumption request to the air pump power consumption control unit 206, and at the same time, the heater power consumption request is withdrawn. The consumption of the regenerative power is started from time point t4 by increasing the rotational speed of the air pump 28 (shown in the fifth row from the top in FIG. 7) to a predetermined rotational speed (step S10, the third power consumption control by the air pump alone).

At time point t6, for example, when the fuel cell vehicle 12 reaches a flat ground from a downhill and starts to park on the flat ground, the motor 46 does not generate regenerative power (step S3: NO). At time point t6, the power consumption request control unit 202 withdraws the air pump power consumption request. After time point t6, the fuel cell system 10 is brought into the idle power generation state.

### Supplementary Note

The following supplementary notes are further disclosed in relation to the above-described disclosure.

### Supplementary Note 1

The fuel cell system 10 comprises: the fuel cell 18 configured to generate electric power by an electrochemical reaction between the fuel gas and the oxygen-containing gas that is supplied from the air pump 28; the fuel cell heat medium supply device 26 configured to supply, to the fuel cell, the heat medium for controlling the temperature of the fuel cell; the fuel cell heat medium temperature sensor 79 configured to detect the temperature of the heat medium for controlling the temperature of the fuel cell; the heater heat medium supply device 27 configured to branch the heat medium flowing from the fuel cell heat medium supply device 26, and supply, to the heater 82, the heat medium that has been branched; the heater heat medium temperature sensor 83 configured to detect the temperature of the heat medium flowing through the heater heat medium supply device 27 and controlling the temperature of the heater; and the switching valve 85 configured to allow or block communication between the heat medium flowing through the fuel cell heat medium supply device and the heat medium flowing through the heater heat medium supply device, the fuel cell system being configured to supply auxiliary device electric power to the air pump, the fuel cell heat medium supply device, and the heater heat medium supply device, and to supply, to the motor 46, driving electric power for causing the motor to generate a driving force, the auxiliary device electric power and the driving electric power being supplied from at least one of the power storage device 44 or the fuel cell, wherein in a case where the power storage device is not chargeable with regenerative power generated by the motor, the switching valve is switched to the communication state to increase the fuel cell heat medium temperature, when the temperature difference (Tht−Tfc) obtained by subtracting the fuel cell heat medium temperature from the heater heat medium temperature becomes equal to or greater than the threshold temperature difference ΔTth while the fuel cell heat medium temperature is lower than the first threshold temperature Th1, and the switching valve is switched to the shut-off state to perform the power consumption control in which the rotational speed of the air pump is increased to cause the regenerative power to be consumed by the air pump, when the fuel cell heat medium temperature becomes equal to or higher than the first threshold temperature.

In this way, in a case where the motor generates regenerative power and the power storage device cannot be charged with the regenerative power, the regenerative power is consumed by the heater alone, both the heater and the fuel cell, and the air pump alone in this order, and therefore, the regenerative power can be consumed accurately without freezing the fuel cell system.

In other words, when regenerative power is generated, the power generation by the fuel cell is in an idle state, and the stack temperature is low. When the stack temperature is low, if the air pump is rotated at a high speed (normally rotated) by the regenerative power, the fuel cell system may freeze. In contrast, in the present invention, by providing a period in which the regenerative power is consumed by the heater alone and a period in which the regenerative power is consumed by both the heater and the fuel cell before the regenerative power is consumed by the air pump alone, the temperature of the fuel cell can be controlled accurately and the regenerative power can be consumed reliably. This in turn contributes to energy efficiency.

### Supplementary Note 2

In the fuel cell system according to Supplementary Note 1, when the fuel cell heat medium temperature is lower than the first threshold temperature, the power consumption control in which the rotational speed of the air pump is increased to cause the regenerative power to be consumed by the air pump is not performed. According to this feature, the fuel cell can be reliably prevented from freezing.

### Supplementary Note 3

In the fuel cell system according to Supplementary Note 1, in a case where the power storage device is not chargeable with the regenerative power generated by the motor, when the fuel cell heat medium temperature is lower than the first threshold temperature and the temperature difference obtained by subtracting the fuel cell heat medium temperature from the heater heat medium temperature is less than the threshold temperature difference, the switching valve is brought into the shut-off state to perform the first power consumption control in which the regenerative power is supplied to the heater and consumed by the heater. In this way, in a case where the regenerative power is generated by the motor and the power storage device cannot be charged with the regenerative power, when the fuel cell heat medium temperature is lower than the first threshold temperature and the temperature difference obtained by subtracting the fuel cell heat medium temperature from the heater heat medium temperature is less than the threshold temperature difference, the switching valve is brought into the shut-off state to perform the first power consumption control in which the regenerative power is consumed by the heater alone. When the regenerative power is generated, the power generation by the fuel cell is in an idle state, and the stack temperature is low. When the stack temperature is low, if the air pump is rotated at a high speed (normally rotated) by the regenerative power, the fuel cell system may freeze. In contrast, during the first power consumption control, the regenerative power is consumed by the heater alone, and therefore, the temperature of the fuel cell can be controlled accurately, and the regenerative power can be consumed reliably. This in turn contributes to energy efficiency.

### Supplementary Note 4

In the fuel cell system according to Supplementary Note 3, during the first power consumption control in which the regenerative power is supplied to the heater and consumed by the heater, when the temperature difference obtained by subtracting the fuel cell heat medium temperature from the heater heat medium temperature becomes equal to or greater than the threshold temperature difference while the fuel cell heat medium temperature is lower than the first threshold temperature, the switching valve is switched to the communication state to perform the second power consumption control in which, while the regenerative power is supplied to the heater and consumed by the heater, the fuel cell heat medium temperature is increased, and the waste heat of the heater is recovered by the fuel cell to warm the fuel cell.

In this way, the second power consumption control is performed in which the regenerative power is consumed by the heater, the heater heat medium heated by the heater is merged with the fuel cell heat medium, and the heat is recovered by the fuel cell. Therefore, the temperature of the fuel cell can be increased while avoiding freezing of the fuel cell system.

### Supplementary Note 5

In the fuel cell system according to Supplementary Note 1, when the switching valve is in the communication state, the opening degree of the switching valve is adjusted to the intermediate opening degree between the fully opened state and the closed state.

In this way, by adjusting the opening degree of the switching valve when the switching valve is in the communication state, the waste heat of the heater heat medium can be accurately recovered by the fuel cell (fuel cell heat medium).

### Supplementary Note 6

In the fuel cell system according to Supplementary Note 1 or 2, when the fuel cell heat medium temperature becomes equal to or higher than the first threshold temperature, the switching valve is switched to the shut-off state to perform the third power consumption control in which power consumption by the heater is stopped, and the rotational speed of the air pump is increased to cause the regenerative power to be consumed by the air pump.

In this way, since the fuel cell heat medium temperature is equal to or higher than the first threshold temperature, in other words, since the temperature of the fuel cell is relatively high, the fuel cell side is warmed up, and therefore, freezing of the fuel cell system can be avoided even if the rotational speed of the air pump is increased. Further, the regenerative power can be reliably consumed by the air pump. In this case, the heater can be operated as a heating air conditioner independently of the fuel cell.

### Supplementary Note 7

In the fuel cell system according to Supplementary Note 1, a case where the regenerative power is generated by the motor is a case where a braking force is generated by the motor when the fuel cell system is descending a downhill.

According to this feature, the regenerative power generated by the motor when the fuel cell system is descending a downhill is consumed by the heater, or the heater and the fuel cell heat medium, or the air pump, whereby the braking force can be reliably generated when the fuel cell system is descending a downhill, and the fuel cell can be prevented from being excessively cooled.

The present invention is not limited to the above disclosure, and various modifications are possible without departing from the essence and gist of the present invention. For example, in the disclosure described above, the heater temperature monitoring unit 212 provided in the regenerative power consumption control unit 200 sends the operation instruction to the switching valve control unit 208, but the switching valve 85 may be controlled based on the waste-heat-recovery permission information via another different control unit.

1. A fuel cell system comprising:
a fuel cell configured to generate electric power by an electrochemical reaction between a fuel gas and an oxygen-containing gas that is supplied from an air pump;
a fuel cell heat medium supply device configured to supply, to the fuel cell, a heat medium for controlling a temperature of the fuel cell;
a fuel cell heat medium temperature sensor configured to detect a temperature of the heat medium for controlling the temperature of the fuel cell;
a heater heat medium supply device configured to branch the heat medium flowing from the fuel cell heat medium supply device, and supply, to a heater, the heat medium that has been branched;
a heater heat medium temperature sensor configured to detect a temperature of the heat medium flowing through the heater heat medium supply device and controlling a temperature of the heater;
a switching valve configured to allow or block communication between the heat medium flowing through the fuel cell heat medium supply device and the heat medium flowing through the heater heat medium supply device; and
a control device,
the fuel cell system being configured to supply auxiliary device electric power to the air pump, the fuel cell heat medium supply device, and the heater heat medium supply device, and to supply, to a motor, driving electric power for causing the motor to generate a driving force, the auxiliary device electric power and the driving electric power being supplied from at least one of a power storage device or the fuel cell,
wherein the control device includes one or more processors that execute computer-executable instructions stored in a memory, and the one or more processors execute the computer-executable instructions to cause the fuel cell system to, in a case where the power storage device is not chargeable with regenerative power generated by the motor:
switch the switching valve to a communication state to increase a fuel cell heat medium temperature, when a temperature difference obtained by subtracting the fuel cell heat medium temperature from a heater heat medium temperature becomes equal to or greater than a threshold temperature difference while the fuel cell heat medium temperature is lower than a first threshold temperature, and
switch the switching valve to a shut-off state to perform power consumption control in which a rotational speed of the air pump is increased to cause the regenerative power to be consumed by the air pump, when the fuel cell heat medium temperature becomes equal to or higher than the first threshold temperature.

2. The fuel cell system according to claim 1, wherein
when the fuel cell heat medium temperature is lower than the first threshold temperature, the one or more processors do not cause the fuel cell system to perform the power consumption control in which the rotational speed of the air pump is increased to cause the regenerative power to be consumed by the air pump.

3. The fuel cell system according to claim 1, wherein
in a case where the power storage device is not chargeable with the regenerative power generated by the motor, when the fuel cell heat medium temperature is lower than the first threshold temperature and the temperature difference obtained by subtracting the fuel cell heat medium temperature from the heater heat medium temperature is less than the threshold temperature difference, the one or more processors cause the fuel cell system to bring the switching valve into the shut-off state to perform first power consumption control in which the regenerative power is supplied to the heater and consumed by the heater.

4. The fuel cell system according to claim 3, wherein
during the first power consumption control in which the regenerative power is supplied to the heater and consumed by the heater, when the temperature difference obtained by subtracting the fuel cell heat medium temperature from the heater heat medium temperature becomes equal to or greater than the threshold temperature difference while the fuel cell heat medium temperature is lower than the first threshold temperature, the one or more processors cause the fuel cell system to switch the switching valve to the communication state to perform second power consumption control in which, while the regenerative power is supplied to the heater and consumed by the heater, the fuel cell heat medium temperature is increased, and waste heat of the heater is recovered by the fuel cell to warm the fuel cell.

5. The fuel cell system according to claim 1, wherein
when the switching valve is in the communication state, the one or more processors cause the fuel cell system to adjust an opening degree of the switching valve to an intermediate opening degree between a fully opened state and a closed state.

6. The fuel cell system according to claim 1, wherein
when the fuel cell heat medium temperature becomes equal to or higher than the first threshold temperature, the one or more processors cause the fuel cell system to switch the switching valve to the shut-off state to perform third power consumption control in which power consumption by the heater is stopped, and the rotational speed of the air pump is increased to cause the regenerative power to be consumed by the air pump.

7. The fuel cell system according to claim 1, wherein
a case where the regenerative power is generated by the motor is a case where a braking force is generated by the motor when the fuel cell system is descending a downhill.
